(19) United States
(12) Patent Application Publication
(10) Pub. No.: US 2008/0102353 A1
(43) Pub. Date: May 1, 2008

(54) Non-aqueous electrolyte secondary battery and manufacturing method of the same

(76) Inventors: Hideharu Takezawa, Osaka (JP); Kazuyoshi Honda, Osaka (JP)

Correspondence Address: MCDERMOTT WILL & EMERY LLP, 600 13TH STREET, NW, WASHINGTON, DC, 20005-3096, US

(21) Appl. No.: 11/976,667

(22) Filed: Oct. 26, 2007

(30) Foreign Application Priority Data
Nov. 1, 2006 (JP) 2006-297391

(51) Int. Cl. H01M 10/02; B05D 5/12

(52) U.S. Cl. 429/94; 427/123

(57) ABSTRACT

In a method for manufacturing a non-aqueous electrolyte secondary battery, a negative electrode having a current collector exposed portion in a portion corresponding to an outer winding end of an electrode body, metallic lithium piece is allowed to precipitate or be deposited on this current collector exposed portion, and this metallic lithium piece is joined to the other portion of the current collector exposed portion or one metallic lithium piece is joined to the other metallic lithium piece so as to fix two points of the negative electrode.

### BACKGROUND OF THE INVENTION

1. Field of the Invention

The present invention relates to a non-aqueous electrolyte secondary battery having an electrode body formed by winding a negative electrode, a positive electrode and a separator therebetween, and a method for manufacturing the same.

2. Background Art

With the widespread use of portable and cordless electronic equipment, the expectation is increasing for compact, light-weight and high energy density non-aqueous electrolyte secondary batteries. At present, carbon materials such as graphite are practically used as a negative electrode active material for a non-aqueous electrolyte secondary battery. In order to further increase the energy density of the non-aqueous electrolyte secondary battery, it has been considered to use a negative electrode active material with a large capacity density, for example, silicon (Si), tin (Sn), germanium (Ge) which uses an alloying reaction with lithium, and oxides or alloys thereof. In the non-aqueous electrolyte secondary battery, in order to achieve a high capacity and high power, a positive electrode and a negative electrode are wound via a separator therebetween so as to form an electrode body. It is advantageous because the amount of active materials to be filled is increased so as to achieve a larger capacity and the reaction area is increased so as to achieve high power. In general, the outer winding end in the electrode body is fixed with an adhesive tape in order that the electrode body does not unwind when this electrode body is being inserted into a case in the manufacturing process. Such a method is disclosed in, for example, Japanese Patent Unexamined Publication No. H7-153488.

However, the volume of the above-mentioned negative electrode active material is changed according to charge and discharge. In particular, such a phenomenon is remarkable in an active material such as Si having a high capacity density. Furthermore, a positive electrode also swells and contracts according to charge and discharge. When such swelling and contraction repeat according to charge and discharge cycles, the electrodes (negative electrode and positive electrode) may be deformed (hereinafter, referred to as “buckling”) inside the electrode body. This occurs because the electrodes swell in a state in which the outer winding end of the electrode body is fixed with the adhesive tape.

When buckling of the electrodes occurs in this way, the distance between the positive electrode and the negative electrode is increased in some places, and the charge and discharge reaction becomes ununiform. As a result, the charge and discharge cycle characteristic is deteriorated.

### SUMMARY OF THE INVENTION

The present invention provides a non-aqueous electrolyte secondary battery, in which unwinding of an electrode body is prevented during a manufacturing process of the battery and which is excellent in a charge and discharge cycle characteristic, The present invention also provides a method for manufacturing the same.

The non-aqueous electrolyte secondary battery of the present invention uses a negative electrode having a current collector exposed portion in a place corresponding to an outer winding end of the electrode body. Then, metallic lithium piece is allowed to precipitate or be deposited on the current collector exposed portion. This metallic lithium piece is joined to the other portion of the current collector exposed portion, or one metallic lithium piece is joined to the other metallic lithium piece. Thereby, two points of the negative electrode are fixed to each other. In other words, it is possible to fix the electrode body without using an adhesive tape. Accordingly, the electrode body does not unwind in the manufacturing process of the battery. When a battery is produced by using this electrode body, joining by metallic lithium piece is released due to the change of a volume of the electrodes according to charge and discharge. As a result, metallic lithium piece remains at least in one portion of the current collector exposed portion. Since a clearance for inserting the electrode body into a case can be used as space for relieving the volume expansion of the electrode it this way, it is possible to suppress buckling of the electrodes according to the progress of the charge and discharge cycle.

When the non-aqueous electrolyte secondary battery and the method for manufacturing the same of the present invention are used, it is possible to provide a non-aqueous electrolyte secondary battery having an excellent charge and discharge characteristic while maintaining productivity.

### BRIEF DESCRIPTION OF THE DRAWINGS

FIG. 1 is a sectional view showing a non-aqueous electrolyte secondary battery in accordance with an embodiment of the present invention.

FIG. 2 is a sectional view showing a portion corresponding to an outer winding end of a negative electrode of the non-aqueous electrolyte secondary battery before the negative electrode is wound in accordance with the embodiment of the present invention.

FIG. 3 is another sectional view showing a portion corresponding to an outer winding end of a negative electrode of the non-aqueous electrolyte secondary battery before the negative electrode is wound in accordance with the embodiment of the present invention.

FIGS. 4A and 4B are schematic sectional views showing metallic lithium piece remaining in a current collector exposed portion when the non-aqueous electrolyte secondary battery is disassembled in accordance with the embodiment of the present invention.

FIG. 5 is a further sectional view showing a portion corresponding to an outer winding end of a negative electrode of the non-aqueous electrolyte secondary battery before the negative electrode is wound in accordance with the embodiment of the present invention.

FIG. 6 is a yet further sectional view showing a portion corresponding to an outer winding end of a negative electrode of the non-aqueous electrolyte secondary battery before the negative electrode is wound in accordance with the embodiment of the present invention.

FIG. 7 is a schematic configuration view showing an apparatus for producing a negative electrode precursor in accordance with the embodiment of the present invention.

FIG. 8 is a schematic configuration view showing an apparatus for vapor-depositing lithium on a negative electrode active material layer of the negative electrode precursor in accordance with the embodiment of the present invention.

### DETAILED DESCRIPTION OF THE INVENTION

Hereinafter, the embodiment of the present invention is described with reference to drawings. Note here that the present invention is not particularly limited to the below described contents as long as it is based on the basic prefectures described in this specification.

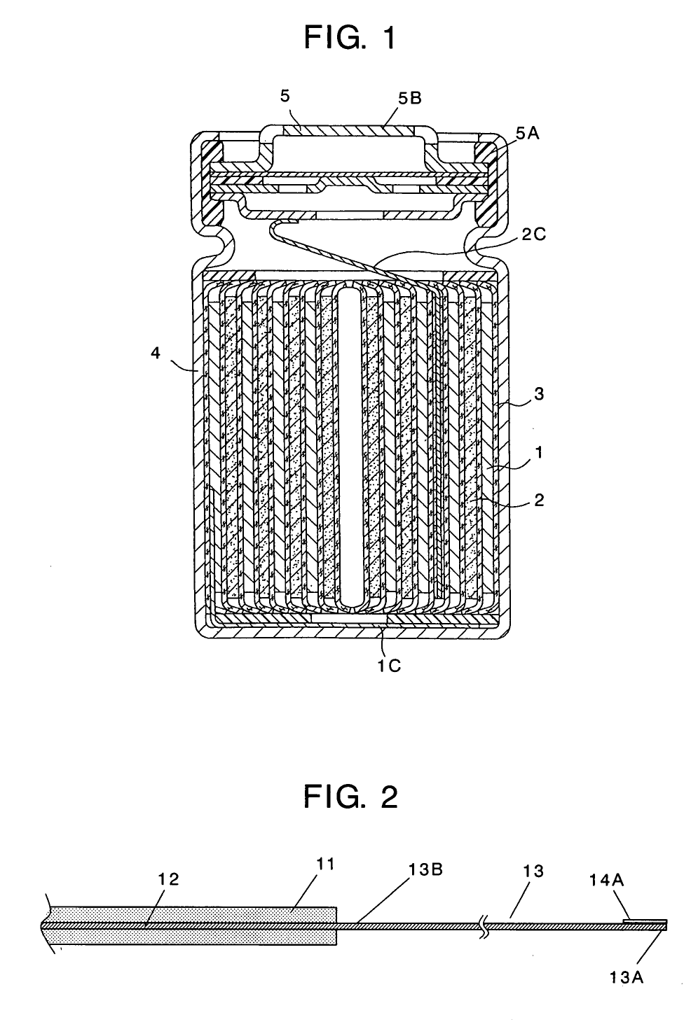

FIG. 1 is a sectional view showing a non-aqueous electrolyte secondary battery in accordance with an embodiment of the present invention. An electrode body as a power generation element of this battery is formed by winding long and thin positive electrode 1 and long and thin negative electrode 2 via separator 3 therebetween. The electrode body thus produced and a non-aqueous electrolyte (not shown) impregnated in the electrode body are accommodated in case 4. Sealing plate 5 seals the opening of case 4. Lead 1C of negative electrode 1 is coupled to case 4 that also works as a negative terminal. Lead 2C of positive electrode 2 is coupled to a metal portion, insulated from case 4, of sealing plate 5. The metal portion works as a positive terminal.

FIG. 2 is a sectional view showing a portion corresponding to an outer winding end of negative electrode 1 of the non-aqueous electrolyte secondary battery before negative electrode 1 is wound in accordance with the embodiment of the present invention. Negative electrode 1 includes negative electrode current collector (hereinafter, referred to as “current collector”) 12 made of a sheet-like conductor and negative electrode active material layers (hereinafter, referred to as “layers”) 11 provided on both surfaces of current collector 12. Furthermore, current collector exposed portion (hereinafter, referred to as “exposed portion”) 13 exposed from layers 11 is provided at an end portion. Metallic lithium piece 14A is provided on winding end position 13A of exposed portion 13 by a gas phase method such as electrodeposition or vapor deposition. The thickness of metallic lithium piece 14A is in the range from about 5 μm to about 20 μm.

Each of layers 11 includes at least an active material capable of absorbing and releasing lithium ions. As such an active material, a carbon material such as graphite or amorphous carbon can be used. Alternatively, it is possible to use materials, for example, silicon (Si), tin (Sn), or the like, which are capable of absorbing and releasing a large amount of lithium ions at a lower potential as compared with a positive electrode active material. Such materials can exert the effect of the present invention regardless of whether such a material is any of an elemental substance, an alloy, a compound, a solid solution and a composite active material containing a silicon-containing material or a tin-containing material. In particular, the silicon-containing material is preferable because it has a large capacity density and is inexpensive. As the silicon-containing materials, Si, SiOₓ (0.05<x<1.95), and an alloy, a compound or a solid solution of any of the above-mentioned materials in which a part of Si is replaced with at least one atom selected from the group consisting of B, Mg, Ni, Ti, Mo, Co, Ca, Cr, Cu, Fe, Mn, Nb, Ta, V, W, Zn, C, N and Sn can be used. As the tin-containing materials, Ni₂Sn₄, Mg₂Sn, SnOₓ (0<x<2), SnO₂, SnSiO₃, LiSnO, and the like can be used.

A negative electrode active material may be formed of these materials singly or in combination with plural kinds of materials. As an example of formation of a negative electrode active material by using plural kinds of materials mentioned above, a compound containing Si, oxygen and nitrogen or a composite of plurality of compounds containing Si and oxygen with different constituting ratio of Si and oxygen can be used. Among them, SiOₓ (0.3≦x≦1.3) is preferable because it has a large discharge capacity density and it has a smaller swelling degree in the charged state as compared with the case where a elemental Si is used.

Each of layers 11 may further include a binder. An example of the binder may include, for example, polyvinylidene-fluoride (PVDF), polytetrafluoroethylene, polyethylene, polypropylene, aramid resin, polyamide, polyimide, polyamide-imide, polyacrylonitrile, polyacrylic acid, polymethylacrylate, polyethylacrylate, polyhexylacrylate, polymethacrylic acid, polymethylmethacrylate, polyethylmethacrylate, polyhexylmethacrylate, polyvinylacetate, polyvinylpyrrolidone, polyether, polyethersulfone, polyhexafluoropropylene, styrene-butadiene rubber, carboxymethylcellulose, and the like. Furthermore, a copolymer of two or more kinds of materials selected from tetrafluoroethylene, hexafluoroethylene, hexafluoropropylene, perfluoro-alkylvinyl ether, vinylidenefluoride, chlorotrifluoroethylene, ethylene, propylene, pentafluoropropylene, fluoromethylvinyl ether, acrylic acid, hexadiene, may be used.

Furthermore, if necessary, a conductive agent may be mixed in layer 11. As the conductive agent, graphites including natural graphites such as flake graphites, artificial graphites, and expanded graphites; carbon blacks such as acetylene black, Ketjen black, channel black, furnace black, lampblack and thermal black; conductive fibers such as carbon fibers and metal fibers; metal powders of copper, nickel, or the like; organic conductive materials such as polyphenylene derivative, and the like can be used. In particular, it is further preferable that fiber carbon materials are attached to negative electrode active material particles so as to form a conductive network of negative electrode active material particles.

For a material of current collector 12 and case 4, a metal foil of stainless steel, nickel (Ni), copper, titanium, and the like, and a thin film of, for example, carbon and conductive resin can be used. Furthermore, surface treatment may be carried out by using carbon, Ni, titanium, or the like.

Positive electrode 2 has a current collector and a positive electrode active material layer including a positive electrode active material. Lead 2C is attached to the positive electrode current collector. Another end of lead 2C is coupled to case 4 that also works as a positive terminal. Note here that positive electrode active material layers are formed on both surfaces of the positive electrode current collector.

The positive electrode active material layer includes a lithium-containing composite oxide such as LiCoO₂, LiNiO₂, and LiMn₂O₄ or a mixture thereof or a composite compound thereof, as a positive electrode active material. In particular, LiₓM_{y}N_{1-y}O₂ is preferable (in the formula, M and N denote at least one selected from the group consisting of Co, Ni, Mn, Cr, Fe, Mg, Al and Zn, contain at least Ni, and satisfy M≠N. 0.98≦x≦1.10 and 0<y<1 are satisfied) because the capacity density is large.

As the positive electrode active material, besides the above-mentioned materials, olivine-type lithium phosphate expressed by the general formula: LiMPO₄ (M=V, Fe, Ni or Mn) and lithium fluorophosphate expressed by the general formula: Li₂ MPO₄F (M=V, Fe, Ni or Mn) can be used. Furthermore, a part of atoms in these lithium-containing compounds may be replaced with a different atom. Surface treatment may be carried out by using metal oxide, lithium oxide, conductive agent, and the like. A surface may be treated to have a hydrophobic property.

The positive electrode active material layer further includes a conductive agent and a binder. As the conductive agent, graphites including natural graphites and artificial graphites; carbon blacks such as acetylene black, Ketjen black, channel black, furnace black, lampblack and thermal black; conductive fibers such as carbon fiber and metal fiber; metal powders such as aluminum powders; conductive whiskers of zinc oxide, potassium titanate, and the like; conductive metal oxide such as titanium oxide; an organic conductive material such as phenylene derivatives, and the like can be used.

As the binder, for example, PVDF, polytetrafluoroethylene, polyethylene, polypropylene, aramid resin, polyamide, polyimide, polyamide-imide, polyacrylonitrile, polyacrylic acid, polymethylacrylate, polyethylacrylate, polyhexylacrylate, polymethacrylic acid, polymethylmethacrylate, polyethylmethacrylate, polyhexylmethacrylate, polyvinylacetate, polyvinylpyrrolidone, polyether, polyethersulfone, hexafluoropolypropylene, styrene-butadiene rubber, carboxymethylcellulose, and the like can be used. Furthermore, a copolymer of two or more kinds of materials selected from tetrafluoroethylene, hexafluoroethylene, hexafluoropropylene, perfluoro-alkylvinyl ether, vinylidenefluoride, chlorotrifluoroethylene, ethylene, propylene, pentafluoropropylene, fluoromethylvinyl ether, acrylic acid, hexadiene, may be used. Furthermore, a mixture including two or more of them may be used.

For the material of the positive electrode current collector or lead 2C, aluminum (Al), carbon, conductive resin, and the like, can be used. Any of these materials, which have been subjected to surface treatment with carbon and the like, may be used.

As the non-aqueous electrolyte, a non-aqueous solution based electrolyte solution in which a solute is dissolved in an organic solvent, and a so-called polymer electrolyte layer including these solutions and immobilized with a polymer can be used. At least in a case that an electrolyte solution is used, it is preferable that separator 3 formed of a nonwoven fabric or microporous membrane of polyethylene, polypropylene, aramid resin, amide-imide, polyphenylene sulfide, polyimide, and the like, is disposed between positive electrode 2 and negative electrode 1 and this is impregnated with an electrolyte solution.

The material of the non-aqueous electrolyte is selected based on the oxidation-reduction potential of the active material, or the other factor. The solute preferred to be used as a non-aqueous electrolyte includes LiPF₆, LiBF₄, LiClO₄, LiAlCl₄, LiSbF₆, LiSCN, LiCF₃SO₃, LiCF₃SO₂, LiN(CF₃CO₂, LiAsF₆, LiB₁₀Cl₁₀, lower aliphatic lithium carboxylate, LiF, LiCl, LiBr, LiI, chloroborane lithium, borates such as lithium bis(1,2-benzenedioleate(2-)-O,O′) borate, lithium bis(2,3-naphthalenedioleate(2-)-O,O′) borate, lithium bis(2,2′-biphenyldioleate(2-)-O,O′) borate, lithium bis(5-fluoro-2-oleate-1-benzenesulfonate-O,O′) borate, and lithium tetraphenyl borate, and the like. Salts generally used for a lithium battery can be applied.

Furthermore, an example of the organic solvent for dissolving the above-mentioned solutes can include ethylene carbonate (EC), propylene carbonate, butylene carbonate, vinylene carbonate, dimethyl carbonate (DMC), diethyl carbonate, ethyl methyl carbonate (EMC), dipropyl carbonate, methyl formate, methyl acetate, methyl propionate, ethyl propionate, dimethoxymethane, γ-butyrolactone, γ-valerolactone, 1,2-diethoxyethane, 1,2-dimethoxyethane, ethoxymethoxyethane, trimethoxy methane, tetrahydrofuran, tetrahydrofuran derivative such as 2-methyltetrahydrofuran, dimethyl sulfoxide, 1,3-dioxolane, dioxolane derivative such as 4-methyl-1,3-dioxolane, formamide, acetamide, dimethylformamide, acetonitrile, propyl nitrile, nitromethane, ethyl monoglyme, phosphotriester, acetic acid ester, propionic acid ester, sulfolane, 3-methyl sulfolane, 1,3-dimethyl-2-imidazolidinone, 3-methyl-2-oxazolidinone, propylene carbonate derivative, ethyl ether, diethyl ether, 1,3-propanesultone, anisole, fluorobenzene, and a mixture of two or more of them. Solvents generally used in a lithium battery can be applied.

Furthermore, additives such as vinylene carbonate, cyclohexylbenzene, biphenyl, diphenyl ether, vinyl ethylene carbonate, divinyl ethylene carbonate, phenylethylene carbonate, diallyl carbonate, fluoroethylene carbonate, catechol carbonate, vinyl acetate, ethylene sulfite, propanesultone, trifluoropropylene carbonate, dibenzofuran, 2,4-difluoroanisole, o-terphenyl, m-terphenyl, and the like, may be included.

The non-aqueous electrolyte may be used as a solid electrolyte by mixing one polymer material or a mixture of one or more of the polymer materials with the above-mentioned solute. An example of the polymer material includes polyethylene oxide, polypropylene oxide, polyphosphazene, polyaziridine, polyethylene sulfide, polyvinyl alcohol, polyvinylidene-fluoride, polyhexafluoropropylene, and the like. Furthermore, the non-aqueous electrolyte may be used in a gel state by mixing with the above-mentioned organic solvent.

Case 4 is made of a metal such as iron, nickel-plated iron, and aluminum. Sealing plate 5 has insulating member 5A for insulating case 4 and metal portion 5B working as a positive terminal. When sealing plate 5 is fixed by caulking case 4 as shown in FIG. 1, insulating member 5A is a gasket compressed by a part of case 4. The gasket is made of a resin material such as rigid polypropylene. When the opening of the case is sealed by hermetic sealing, insulating member 5A is made of an inorganic material such as glass. Note here that an explosion-proof mechanism, which operates when the internal pressure of the battery is increased, may be incorporated in sealing plate 5.

Next, a procedure for producing a non-aqueous electrolyte secondary battery is described. Firstly, an example of a procedure for manufacturing negative electrode 1 is described. Powdery negative electrode active material classified into a predetermined range of grain size is stirred with a binder, a conductive agent and an appropriate amount of dispersion medium so as to prepare a negative electrode mixture paste. This paste is coated on both surfaces of current collector 12, and dried. At this time, in order to form exposed portion 13, the negative electrode mixture paste is coated intermittently so as to provide an uncoated portion having a length corresponding to a length of the outer winding end of the electrode body. Then, roll-pressing is carried out, if necessary. Thus, a negative electrode precursor, in which layers 11 are formed on both surfaces of current collector 12, is produced. Thereafter, metallic lithium piece 14A is provided in an uncoated portion corresponding to winding end position 13A in exposed portion 13 by electrodeposition or a gas phase method such as vapor deposition. In other words, metallic lithium piece 14A is allowed to precipitate or be deposited on at least a part of exposed portion 13. Thereafter, it is cut by a slitter so as to have a width capable of being inserted into case 4 and to be wider than positive electrode 2. Furthermore, lead 1C is coupled to exposed portion 13 or an exposed portion of current collector 12 that has been provided besides exposed portion 13. Thus, negative electrode 1 is produced.

Alternatively, a negative electrode precursor may be produced by accumulating a negative electrode active material onto current collector 12 so as to form layer 11 by using a gas phase method.

Next, a method for manufacturing positive electrode 2 is described briefly. Powdery positive electrode active material classified into a predetermined range of grain size is stirred with a binder, a conductive agent and an appropriate amount of dispersion medium so as to prepare a positive electrode mixture paste. This paste is coated on both surfaces of the positive electrode current collector, dried, and then roll-pressed. Thus, positive electrode active material layers are formed on both surfaces of the positive electrode current collector, respectively. Thereafter, it is cut by a slitter so as to have a width capable of being inserted into case 4. Furthermore, a part of the positive electrode active material layer is peeled off and lead 2C is coupled to the positive electrode current collector. Thus, positive electrode 2 is produced.

The negative electrode 1 and positive electrode 2 thus produced are wound via separator 3 therebetween so as to form an electrode body. At this time, negative electrode 1 is disposed so that exposed portion 13 comes to the outer winding end. When they are wound, the length of separator 3 is adjusted so that exposed portion 13 is wound without interposing separator 3 after winding of positive electrode 2 is completed, and metallic lithium piece 14A and a portion in which metallic lithium piece 14A is not provided of exposed portion 13 are joined to each other. The electrode body is fixed by this joining so that the electrode body does not unwind. Then, lead 1C is folded and a lower insulting plate is inserted between the electrode body and lead 1C. Thereafter, the electrode body is inserted into case 4. Then, lead 1C is welded to case 4. On the other hand, lead 2C is welded to sealing plate 5 on which gasket 5A is mounted.

Then, a predetermined amount of non-aqueous electrolyte is filled in case 4 and impregnated into at least separator 3. Finally, an opening of case 4 is sealed by caulking. In this way, a non-aqueous electrolyte secondary battery is completed.

After completion, the non-aqueous electrolyte secondary battery is charged and discharged. At this time, stress is generated in the electrode body due to swelling and contraction of the active materials in positive electrode 2 and negative electrode 1. With this stress, joining by metallic lithium piece 14A is released. In this state, the electrode body can swell to the inner diameter of case 4. In other words, a clearance for inserting the electrode body into case 4 can be used as space for relieving the volume expansion. As a result, it is possible to suppress buckling of negative electrode 1 and positive electrode 2 according to the progress of charge and discharge cycle. Consequently, even if charge and discharge are repeated, a high-load discharging characteristic or a low-temperature characteristic can be maintained.

The thickness of metallic lithium piece 14A is in the range from about 5 μm to 20 μm and is thinner than an adhesive tape used conventionally for fixing the outer winding end of an electrode body, so that distortion in the cross-section of the electrode body can be relieved. Accordingly, the electrode body may be inserted into case 4 easily. Furthermore, when a conventional tape made of a polymer material is used, an adhesive component of the tape may react with a non-aqueous electrolyte for a long period of time so as to affect the battery reaction and to deteriorate the reliability. On the other hand, since metallic lithium piece 14A does not face positive electrode 2, it is not involved in the charge and discharge reaction. Furthermore, since metallic lithium piece 14A reacts with a non-aqueous electrolyte so as to be coated with an inactive coating, it is chemically stable.

It is preferable that metallic lithium piece 14A is provided on winding end position 13A of exposed portion 13. This makes it possible to join exposed portion 13 as a part of negative electrode 1 and winding end position 13A to each other reliably regardless of the winding precision of the electrode body.

When the non-aqueous electrolyte secondary battery is disassembled after charge and discharge, metallic lithium piece 14A may not remain on winding end portion 13A but may be moved to proximity portion 13B that is in the proximity of layer 11 in joined exposed portion 13. Alternatively, metallic lithium piece 14A is torn when the non-aqueous electrolyte secondary battery is disassembled, and metallic lithium piece 14A may remain on both winding end position 13A and proximity portion 13B. In other words, at least one metallic lithium piece may remain in at least one portion of exposed portion 13, as a result.

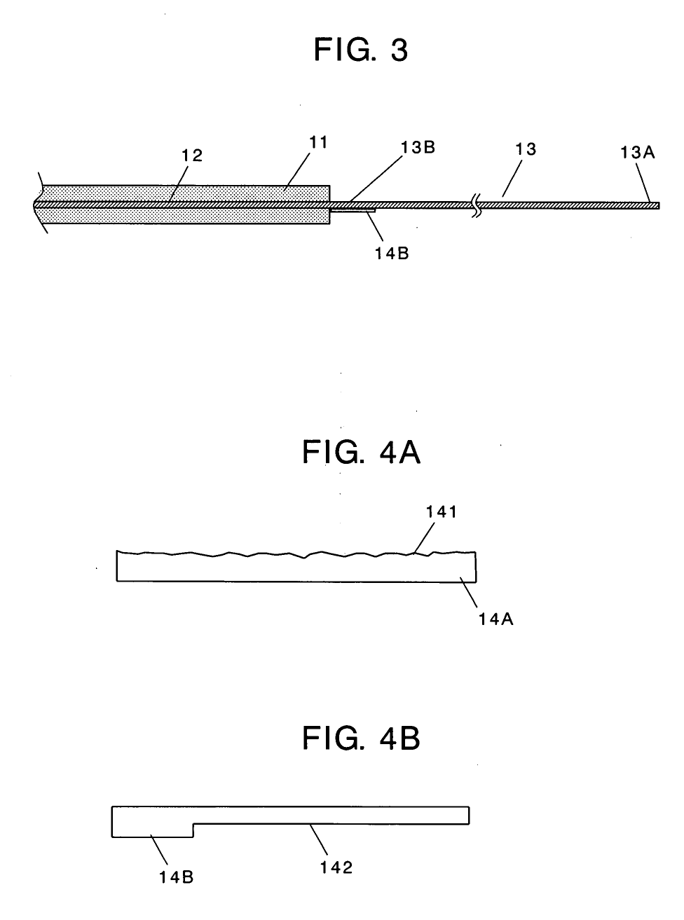

Thus, metallic lithium piece 14A is not necessarily provided on winding end position 13A. In other words, metallic lithium piece 14B may be provided on proximity portion 13B as shown in FIG. 3. In particular, when a negative electrode active material having a high capacity density is used, in order to compensate for a large irreversible capacity, it is necessary to allow metallic lithium piece to precipitate or be deposited on negative electrode 1 before an electrode body is formed. At this time, by allowing metallic lithium piece to precipitate or be deposited on a portion from layer 11 to exposed portion 13, a configuration shown in FIG. 3 can be obtained simultaneously.

In the case where metallic lithium piece 14A is provided on winding end position 13A as shown in FIG. 2, metallic lithium piece 14A is joined to a portion in which metallic lithium piece 14A is not provided in exposed portion 13 when an electrode body is produced. Accordingly, when the non-aqueous electrolyte secondary battery is disassembled after charge and discharge, joined trace 141 with respect to the joined portion remains on metallic lithium piece 14A as shown in FIG. 4A. On the other hand, in the case where metallic lithium piece 14B is provided on proximity portion 13B as shown in FIG. 3, metallic lithium piece 14B is joined to a portion in which metallic lithium piece 14B is not provided in exposed portion 13 when an electrode body is produced. Occasionally, it may be joined to winding end position 13A. Accordingly, when the non-aqueous electrolyte secondary battery is disassembled after charge and discharge, joined trace 142 with respect to winding end position 13A may remain on metallic lithium piece 14B as shown in FIG. 4B.

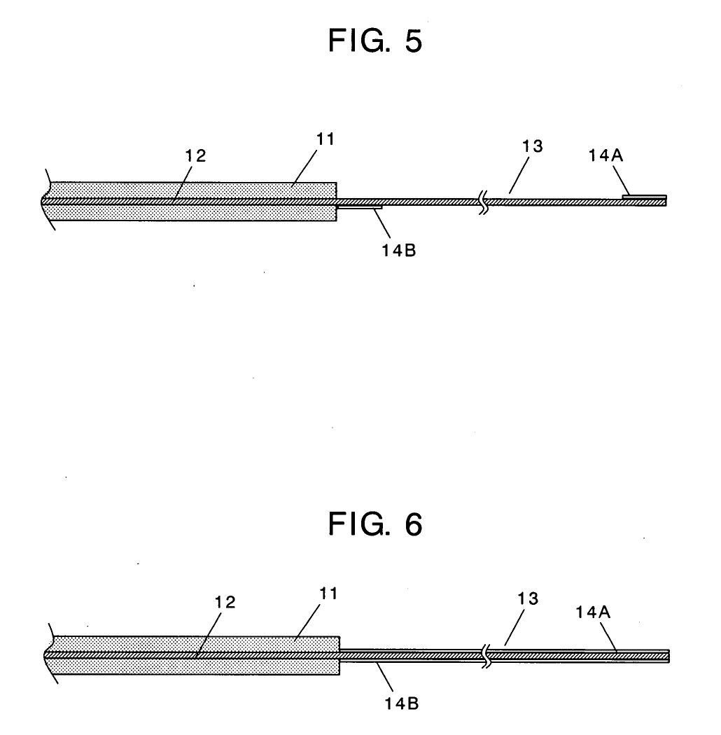

Furthermore, metallic lithium pieces 14A and 14B may be provided on two different portions in exposed portion 13 in a direction in which the electrode body is wound and are brought into contact with each other when an electrode body is produced as shown in FIG. 5. When metallic lithium pieces 14A and 14B provided in two portions are joined to each other in this way, they are joined to each other somewhat more strongly than the case where metallic lithium piece 14A and current collector 12 formed of metal such as copper are joined to each other, and the shape of the electrode body is maintained more reliably. Furthermore, metallic lithium pieces 14A and 14B may be provided on the entire surface of exposed portion 13 as shown in FIG. 6.

Because a joined trace remains on the metallic lithium piece in this way, it is shown that the metallic lithium piece fixes the electrode body reliably in the production of the electrode body. Furthermore, joining by metallic lithium piece is released according to charge and discharge, thereby buckling of the electrode is suppressed.

In FIG. 1, separator 3 is disposed on the outermost peripheral portion of the electrode body. However, since current collector 12 and case 4 are coupled to each other by lead 1C, it is not necessary that exposed portion 13 disposed on the outer winding end and case 4 should be insulated from each other. Therefore, it is not necessary that separator 3 should be disposed on the outermost peripheral portion. However, when metallic lithium piece is provided on the entire surface of exposed portion 13 as shown in FIG. 6, it is preferable that separator 3 is disposed on the outermost peripheral portion by considering the inserting workability of the electrode body into case 4.

Hereinafter, the effects of the embodiments of the present invention are described with reference to specific samples A, B and C.

(1) Production of Batteries for Evaluation

(A) Sample A

(a) Production of Negative Electrode

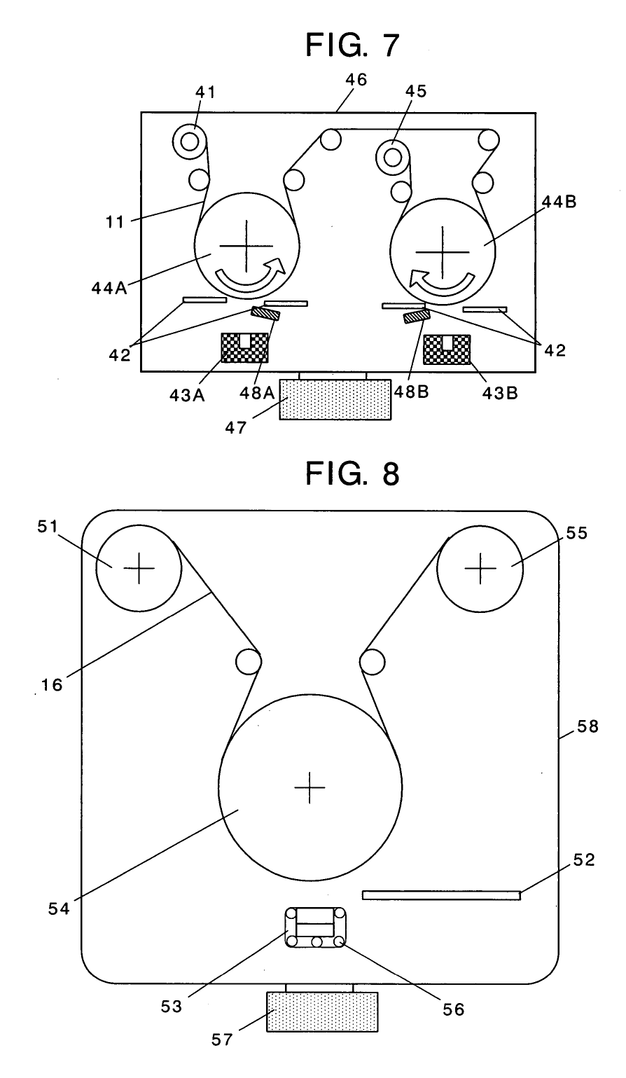

A negative electrode precursor is produced by using a manufacturing apparatus shown in FIG. 7. In this manufacturing apparatus, current collector 12 is sent from winding-out roll 41 to winding-up roll 45 by way of film-formation rolls 44A and 44B. These rolls and vapor deposition units 43A and 43B are provided in vacuum chamber 46. The pressure inside vacuum chamber 46 is reduced by using vacuum pump 47. Each of vapor deposition units 43A and 43B includes a vapor deposition source, a crucible and an electron beam generator.

As current collector 12, a 30 μm-thick electrolytic copper foil provided with concavity and convexity, where Ra is 2.0 μm, by electrolytic plating is used. The inside of vacuum chamber 46 is an argon atmosphere with the pressure of 3.5 Pa. At the time of vapor deposition, an electron beam generated by the electron beam generator is polarized by a polarization yoke, and the vapor deposition source is irradiated with the electron beam. As the vapor deposition source, a scrap material (scrap silicon: purity 99.999%) generated when semiconductor wafers are manufactured is used. Meanwhile, oxygen gas with purity of 99.7% is introduced into vacuum chamber 46 from oxygen nozzle 48A disposed in the vicinity of current collector 12. The opening of shutter 42 allows silicon vapor to enter the surface of current collector 12 as vertically as possible.

Furthermore, a portion on which layer 11 is not formed and current collector 12 is exposed is formed by opening and closing shutter 42. Thereafter, current collector 12 is sent to film-formation roll 44B. Oxygen gas is introduced from oxygen nozzle 48B into vacuum chamber 46 while silicon vapor is generated from vapor deposition unit 43B, so that layer 11 is formed on the other surface of current collector 12. With this method, a negative electrode precursor having layers 11 made of SiO_{0.3} on current collector 12 is produced.

Subsequently, by using a vacuum vapor deposition device shown in FIG. 8, lithium having a thickness corresponding to 10 μm is vapor-deposited on negative electrode precursor 16 under the conditions mentioned below. Firstly, negative electrode precursor 16 is set so that it is sent from winding-out roll 51 to winding-up roll 55 via film formation can roll 54. Next, evaporation boat 53 made of tantalum is used and a lithium metal rod is put in evaporation boat 53 as an evaporation source. Next, the pressure inside vacuum chamber 58 is reduced by using vacuum pump 57. Thereafter, heater 56 incorporated in evaporation boat 53 is coupled to a DC power source disposed outside vacuum chamber 58. The lithium metal rod is evaporated by a resistance heating method in this way so as to allow lithium to be vapor-deposited on negative electrode precursor 16.

The conditions at this time are set as follows: the degree of vacuum is set to be 0.9 Pa and the rotation speed of film-formation can roll 54 is set to be 10 cm/min. After lithium is vapor-deposited, argon having the purity of 99.999% and oxygen having the purity of 99.999% are introduced simultaneously at the volume ratio of 95:5 so as to return to the atmospheric pressure. The start and end of the vapor deposition is controlled by opening and closing shutter 52 between evaporation boat 53 as a vapor deposition source and negative electrode precursor 16.

Furthermore, at this time, by opening and closing shutter 52, lithium is vapor-deposited on layer 11 and at the same time, lithium is also vapor-deposited on a part of exposed current collector 12 between layers 11 of negative electrode precursor 16. Negative electrode precursor 16 is cut so that exposed portion 13 having at least a length of the outermost peripheral portion is secured between the lithium vapor-deposited on current collector 12 in this way and layer 11. Then, lead 1C made of Ni is welded to a portion in which lithium is not vapor-deposited and which is to be at a position 5 mm apart from the inner winding end of the electrode body in exposed portion 13. Thus, negative electrode 1 of sample A having a configuration shown in FIG. 2 is produced. The width of metallic lithium piece 14A in FIG. 2 is set to be 5 mm.

(b) Production of Positive Electrode

Positive electrode 2 having a positive electrode active material capable of absorbing and releasing lithium ions is produced by the following method. Firstly, 93 parts by weight of LiCoO₂ powder as a positive electrode active material and 4 parts by weight of acetylene black as a conductive agent are mixed. The obtained powder is mixed with an N-methyl-2-pyrrolidone (NMP) solution containing PVDF as a binder so that the weight of PVDF becomes 3 parts by weight. By adding an appropriate amount of NMP to the obtained mixture, a positive electrode mixture paste is prepared. The obtained positive electrode mixture paste is coated on both surfaces of the positive electrode current collector (thickness: 15 μm) made of aluminum (Al) foil by a doctor blade method, and sufficiently dried at 85° C. Furthermore, the dried one is roll-pressed so that the density of the positive electrode mixture layers becomes 3.5 g/cm³ and the thickness thereof becomes 160 μm. After cutting this and providing an exposed portion of the positive electrode current collector, lead 2C made of Al is welded the exposed portion so as to obtain positive electrode 2.

(c) Production of Battery

Negative electrode 1 and positive electrode 2 produced as mentioned above are wound via 20 μm-thick separator 3 made of porous polypropylene therebetween. Then, metallic lithium piece 14A vapor-deposited on the outermost end portion of exposed portion 13 is joined to a portion of exposed portion 13 inside the outermost end portion by one turn so as to form an electrode body. Then, the obtained electrode body and a solution of LiPF₆ dissolved in a mixtures solvent of ethylene carbonate/ethylmethyl carbonate (volume ratio 1:2) as an electrolyte are accommodated in case 4. The opening of case 4 is sealed with sealing plate 5 and gasket 5A so as to produce a cylindrical battery having a diameter 18 mm and a total height of 65 mm. The design capacity of the battery is set to be 2800 mAh. This battery is defined as sample A of battery.

(B) Sample B

For producing negative electrode 1 of sample B, negative electrode precursor 16 of sample A is used and lithium is vapor-deposited so as to have a configuration shown in FIG. 3. That is to say, by controlling the opening and closing of shutter 52, 10 μm-thick lithium is vapor-deposited on layer 11 and a portion of the exposed portion of current collector 12 in the proximity of layer 11. Then, negative electrode precursor 16 is cut so that current collector 12 including the vapor-deposited lithium is provided with exposed portion 13 having at least a length of the outermost peripheral portion. Then, lead 1C made of Ni is welded to a portion in which lithium is not vapor-deposited and which is to be at a position 5 mm apart from the inner winding end of the electrode body in exposed portion 13. Thus, negative electrode 1 of sample B having a configuration as shown in FIG. 3 is produced. The width of metallic lithium piece 14B in FIG. 3 is set to be 5 mm.

When an electrode body is produced, the outer winding end of exposed portion 13 is joined to lithium that has been vapor-deposited on a portion of exposed portion 13 inside the outermost end portion by one turn. The battery of sample B is produced by the same manner as that of sample A except for this.

(C) Sample C

For producing negative electrode 1 of sample C, negative electrode precursor 16 of sample A is used and lithium is vapor-deposited so as to have a configuration shown in FIG. 5. The width of metallic lithium pieces 14A and 14B in FIG. 5 is set to be 5 mm, respectively. Metallic lithium piece 14A and metallic lithium piece 14B are jointed to each other so as to form an electrode body. The battery of sample C is produced by the same manner as that of sample A except for this.

(D) Comparative Sample

A negative electrode of a comparative sample is produced by the same manner as that of sample A except that opening and closing of shutter 52 is controlled so that lithium is vapor-deposited on only layer 11 in the production of the negative electrode of sample A. By using this negative electrode, a battery of the comparative sample is produced by the same manner as that of sample A. When an electrode body is produced, the electrode body is fixed by attaching a 50 μm-thick polypropylene adhesive tape to the outer winding end of the negative electrode.

(2) Evaluation of Batteries

(2-1) Measurement of Battery Capacity

Each of the batteries produced as mentioned above is charged and discharged at environmental temperature of 25° C. under the below-mentioned conditions. Firstly, charging is carried out at constant current at hour rate of 0.5 C (1400 mA) with respect to the design capacity (2800 mAh) until the battery voltage becomes 4.2 V. Then, constant voltage charging for attenuating to the current value of hour rate of 0.05 C (140 mA) at 4.2 V of constant voltage is carried out. Thereafter, the battery is in a rest for 30 minutes. Then, constant current discharging is carried out at a current value of hour rate of 1.0 C (2800 mA) until the battery voltage is reduced to 2.5V. The above-mentioned charging and discharging is defined as one cycle. The discharge capacity in the third cycle is defined as the battery capacity.

(2-2) Evaluation of Charge and Discharge Cycle Characteristic

The above-mentioned charge and discharge cycle is repeated 100 times. The ratio of the discharge capacity in the 100th cycle with respect to the discharge capacity in the first cycle expressed by percentage is calculated as a capacity retention ratio (%). It is shown that as the capacity retention ratio is nearer to 100, the charge and discharge cycle characteristic is more excellent.

(2-3) Observation of Buckling State of Electrode Body

In the charging state after 100 cycles, a state of buckling of the electrode body is observed by observing a cross-section in the height direction of the battery by X-ray computed tomography (CT). Furthermore, the battery in the discharged state after 100 cycles is disassembled so as to observe the winding state of the electrode body and the state of the joining portion of metallic lithium piece on the outer winding end of the negative electrode.

The parameters and evaluation result of each sample are shown in Table 1.

TABLE 1

| | | | Battery | Capacity retention | Buckling of | | |
|---|---|---|---|---|---|---|---|
| | (1) | (2) | capacity (mAh) | ratio (%) | electrodes | (3) | (4) |
| Sample | | not | 2805 | 90 | not | observed | observed |
| A | | used | | | observed | | |
| Sample | | not | 2810 | 90 | not | observed | observed |
| B | | used | | | observed | | |
| Sample | | not | 2800 | 90 | not | observed | observed |
| C | | used | | | observed | | |
| Comparative | — | used | 2780 | 75 | observed | — | not |
| sample | | | | | | | observed |

(1) Configuration of vapor-deposited lithium on current collector exposed portion;
(2) Adhesive tape on the outer winding end;
(3) Joined trace of lithium in exposed portion;
(4) Unwinding of electrodes

In any of the batteries of samples A, B and C and the comparative sample, a battery capacity near the design capacity is obtained. However, according to the evaluation results of the charge and discharge cycle characteristic, samples A, B and C show the capacity retention ratio of 90% while the comparative example shows only 75%. The results of the X-ray CT observation show that the electrode body buckles after the cycle test in the comparative sample. Therefore, it is thought that the closeness between negative electrode 1 and positive electrode 2 in the electrode body is reduced and the internal resistance is increased. Accordingly, it is thought that the capacity retention ratio is low.

On the other hand, such a buckling is not observed in samples A, B and C. Furthermore, according to the results of the observation of the battery dissembled after the charging and discharging cycle test, metallic lithium piece 14A or metallic lithium piece 14B vapor-deposited on exposed portion 13 no longer fixes the electrode body, and a lithium piece with a joined trace is shown in exposed portion 13. From these results, it is thought that fixation of the electrode body by metallic lithium piece 14A or metallic lithium piece 14B is released after each of the batteries of samples A, B and C is assembled or during charge and discharge of the each battery, and that a clearance for inserting the electrode body into case 4 can be used as space for relieving the volume expansion of the electrode. As a result, it is estimated that buckling of negative electrode 1 and positive electrode 2 due to the progress of charge and discharge cycle is suppressed and that the charge and discharge cycle characteristic is excellent.

Note here that in the above-mentioned embodiment, a cylindrical battery is described as an example; however, the above-mentioned embodiment can be also applied to a prismatic battery.

As mentioned above, according to the present invention, a negative electrode having a current collector exposed portion in a portion corresponding to the outer winding end of an electrode body is used, and metallic lithium piece is allowed to precipitate or be deposited on this current collector exposed portion. By joining this metallic lithium piece to the other portion of the current collector exposed portion or joining one metallic lithium piece to the other metallic lithium piece, two portions of the negative electrode are fixed. Consequently, the electrode body does not unwind in the manufacturing process of a battery, and it can be handled easily, so that the productivity is maintained. When a battery is configured by using this electrode body, joining by metallic lithium piece is released due to swelling of the electrode according to charge and discharge. As a result, at least one metallic lithium piece remains at least in one portion of the current collector exposed portion. Since a clearance for inserting the electrode body into the case can be used as space for relieving the volume expansion of the electrode, it is possible to suppress buckling of the electrode according to the progress of charge and discharge cycle. In particular, the present invention is useful to a non-aqueous electrolyte secondary battery using a negative electrode active material with a large capacity density.

What is claimed is:

1. A non-aqueous electrolyte secondary battery, comprising:
a negative electrode including a sheet-like negative electrode current collector made of a conductor, negative electrode active material layers formed on both surfaces of the negative electrode current collector, a current collector exposed portion provided on an end portion of the negative electrode current collector and exposed from the negative electrode active material layers, and a metallic lithium piece provided on at least one portion of the current collector exposed portion;
a positive electrode provided facing the negative electrode;
a non-aqueous electrolyte; and
a separator interposed between the negative electrode and the positive electrode and impregnated with the non-aqueous electrolyte;
wherein the negative electrode, the positive electrode and the separator are wound so as to form an electrode body, and the current collector exposed portion is provided on an outer winding end of the electrode body.

2. The non-aqueous electrolyte secondary battery according to claim 1, wherein the metallic lithium piece has a joined trace with respect to a position other than the metallic lithium piece in the negative electrode.

3. The non-aqueous electrolyte secondary battery according to claim 1, wherein the metallic lithium piece is one of two metallic lithium pieces, and the two metallic lithium pieces are provided on two different portions in the current collector exposed portion in a direction in which the electrode body is wound.

4. The non-aqueous electrolyte secondary battery according to claim 1, wherein the metallic lithium piece is provided in a vicinity of the negative electrode active material layer.

5. The non-aqueous electrolyte secondary battery according to claim 1, wherein the metallic lithium piece is provided at a winding end portion of the current collector exposed portion.

6. A method for manufacturing a non-aqueous electrolyte secondary battery, the method comprising:
(A) producing a negative electrode including a sheet-like negative electrode current collector made of a conductor, negative electrode active material layers formed on both surfaces of the negative electrode current collector, and a current collector exposed portion provided on an end portion of the negative electrode current collector and exposed from the negative electrode active material layers;
(B) allowing metallic lithium piece to precipitate or be deposited on at least a part of the current collector exposed portion; and
(C) winding the negative electrode and the positive electrode via a separator therebetween so that the current collector exposed portion becomes an outer winding end so as to form an electrode body after step B, two portions of the negative electrode being fixed with the metallic lithium piece.

7. The method according to claim 6, wherein the metallic lithium piece is provided in a vicinity of the negative electrode active material layer in step B.

8. The method according to claim 6, wherein the metallic lithium piece is provided in a winding end portion of the current collector exposed portion in step B.

9. The method according to claim 6, wherein the metallic lithium piece is one of two metallic lithium pieces, and the two metallic lithium pieces are provided in two different portions in the current collector exposed portion in a direction in which the electrode body is wound in step B.
